(19) United States
(12) Patent Application Publication
(10) Pub. No.: US 2012/0174206 A1
(43) Pub. Date: Jul. 5, 2012

(54) SECURE COMPUTING ENVIRONMENT

(75) Inventors: Gary Spear, Broomfield, CO (US); Ken Davidson, Boulder, CO (US); Daniel Pierson, Denver, CO (US); Ryan Hebb, Littleton, CO (US); Michael Dean Kleck, Lakewood, CO (US)

(73) Assignee: Alpine Access, Inc., Denver, CO (US)

(21) Appl. No.: 13/030,919

(22) Filed: Feb. 18, 2011

Related U.S. Application Data
(60) Provisional application No. 61/428,992, filed on Dec. 31, 2010.

(51) Int. Cl. G06F 7/04; G06F 9/00; G06F 15/16

(52) U.S. Cl. 726/9; 726/12; 713/2

(57) ABSTRACT

Techniques and apparatus are provided for a secure computing environment. In particular, in some embodiments a secure computing environment is provide by requesting, by a processor, booting of a virtual machine on a first computing device. A hash value of the virtual machine is verified and it is determined whether an external storage device is present. The result of the verification is written to an environment variable. Additionally, it is determined if the external storage device is paired with the first computing device and the result of the determination is written to an environment variable. The virtual machine is then booted by the first computing device.

### CROSS-REFERENCE TO RELATED APPLICATIONS

This application is related to and claims priority to U.S. Provisional Patent Application No. 61/428,992, filed Dec. 31, 2010, and entitled, “Secure Computing Environment,” which is incorporated herein by reference in its entirety and for all purposes.

### BRIEF DESCRIPTION

The present disclosure generally relates to communication systems and, more particularly, to secure communication systems for the collection and transfer of data.

### BACKGROUND

Generally, call centers may be configured to handle a variety of call types including incoming and outgoing calls. For example, calls may include telemarketing efforts, political polling, customer service calls, warranty service calls, and so forth. In some cases, the calls may include a collection and/or transfer of data that should be treated in a manner to protect the data.

Call centers may operate according to one or more different models. Two common models that may be implemented include a centralized call center model and a distributed call center model. In the centralized model, a common physical location houses the equipment and agents. The distributed model may include a network having multiple locations housing equipment and agents. In both the centralized and distributed models, the equipment (e.g., telephones, computers, and so forth) may be owned and controlled by the call center. Yet another model is a home based model. The home based model is a variant of the distributed model and allows agents to work from their homes. In some cases, the agents may own and use their own equipment. As may be appreciated, the home-based model may present reliability, consistency, and security issues. In some cases, a call center's client may request or require certain security and reliability measures to be implemented for their projects.

### SUMMARY

Measures for increased security and reliability for home based call centers, and methods related thereto, are described herein. In particular, in some embodiments, security checks may be made at a host system and/or at a gateway device prior to allowing access to a call center network. As used herein, “gateway device” may refer to a computing device configured to verify information prior to allowing access to resources and/or networks. The gateway device may take any suitable form, such as a virtual private network (VPN) concentrator, VPN gateway, or other suitable computing device that is situated between a user and network, such as a local area network (LAN), and which limits access to the network. In some embodiments, reference to the gateway device may include a first device, such as a VPN concentrator, and a second device, such as a check server which verifies information. Moreover, the gateway device may be referred to herein as “gateway device,” “gateway computer,” “gateway,” or other suitable names.

The checks performed by the gateway device may include verification that certain programs and or software are installed and operating, as well as verification of hardware configurations. In some embodiments, the checks may include checking a hash value from host system information and comparing it known values at the gateway. If the hash values are not verified, the gateway may deny access to a call center's network.

In some embodiments, the call center may distribute computing systems to agents. The distributed systems may be specifically configured for the purposes of the call center and/or a particular client. As such, the system may be limited in its installed hardware, software, and/or its connectivity with external networks and/or I/O devices. The limited functionality of the system increases the security of the system by limiting opportunity for malware or viruses to infect the device and may also devalue the system for resale purposes.

In some embodiments, an external storage device may be implemented for security purposes. The external storage device may be used to support instantiating a secure, virtual computing environment. The virtual computing environment may limit a user's access to computing resources. Additionally, in some embodiments, the contents of the external security device may be verified prior to allowing access to the network. Further, the external storage device may be non-transferrably paired with a particular host computing device. Hence, if the external storage device is used with a computer to which it is not paired, an attempt to become instantiated will fail. In some embodiments, instantiation may occur and later the computer may shut down if the external storage device is not paired to the computer.

In some embodiments, the installed hardware and software of the host computing system may be verified before allowing a secure guest computing system access to a network. For example, a “thumbprint” file may be provided for identification purposes. The thumbprint file may be stored at a particular location on the device, may include a identifying information and may be configured for a particular client. A copy of the thumbprint file may be transferred to a gateway device for verification.

The authentication process for access to a network may include a verification at a local level and at the network level. That is, software on a local computing device may verify a particular configuration of the device. Additionally, a gateway device may verify a particular configuration of the computing device at the network level. That is, the gateway device may store verification information for the computing device, such as a hash value, serial numbers for hardware devices, a number indicating how many I/O devices are installed, and so forth. As such, the system, or certain parts of a system, may be verified twice.

In some embodiments, security measures may be implemented to help ensure that no unauthorized devices access the call center's network. For example, in some embodiments, device identifying information may be checked to see if any modifications have been made to issued devices that could potentially present security issues.

In some embodiments a secure computing environment is provide by requesting, by a processor, booting of a virtual machine on a first computing device. A hash value of the virtual machine is verified and it is determined whether an external storage device is present. The result of the verification is written to an evironment variable. Additionally, it is determined if the external storage device is paired with the first computing device and the result of the determination is written to an environment variable. The virtual machine is then booted by the first computing device.

Moreover, in some embodiments, a secure computing environment is provided by pairing an external storage device with a computing device. The pairing includes reading a first code from the external storage device and if the first code indicates a default value: reading an expiration date from the external storage device and determining if the expiration date has passed. If the expiration date has not passed, replacing the first code with a second code to pair the external storage device with the computing device. Additionally, if the first code does not indicate the default value, comparing the first code matches with third code stored on the computing device to determine if the external storage device has been paired with the computing device.

In still other embodiments, a secure computing environment for accessing a network includes an agent computing device having a processor and a memory coupled to the processor storing instructions executable by the processor to provide secure call center functionality. The agent computing device is configured to generate a first hash value. Additionally, the secure computing environment includes a gateway device having a second processor and a memory coupled to the second processor storing a second hash value. The gateway device is configured to verify the first hash value prior to allowing the agent computing device access to a network.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates an example network with an agent, a call center and a client.

FIG. 2 is a block diagram of the agent computing system of FIG. 1.

FIG. 3 illustrates the agent computing system of FIG. 2 and an external storage device.

FIG. 4 is a flow chart illustrating a method for securely connecting to a network using a computing device.

FIG. 5 is a flowchart illustrating a method of securely connecting to a network using a virtual computing environment.

FIG. 6 is a flowchart illustrating other aspects of the method for securely connecting to a network shown in FIG. 5.

### DETAILED DESCRIPTION

A secure computing environment and related methods are described herein. The environment may include one or more computing devices that are networked together to allow for communications therebetween. In some embodiments, a first computing device is provided to the agent for use when accessing the network. The first computing device may be configured as a closed system with limited hardware and software resources. As such, it may be configured solely for the purpose of connecting to the network and transferring information thereto. Additionally, the first computing device may verify its configuration prior to attempting to connect with the network. That is, for example, the first computing device may be configured to verify the software and hardware installed on the system. A second computing system, such as a gateway device, may additionally verify the identity and/or contents of the first computing system and the credentials of its user. As such, there may be multiple checks of the first system prior to allowing access to the network.

In some embodiments, an external storage device may be provided that is configured to couple to the first computing device and to initiate a secure operating environment. The secure operating environment may be referred to herein as a “secure computing environment,” a “secure remote desktop,” “secure desktop,” or the like. Additionally, the external storage device may be referred to as a “jump drive,” a “storage device,” or “SRD.” The secure operating environment session may include running instructions from the external storage device that provide security to the computing device. In the secure operating environment session, a virtual computing environment is presented that may force a user to provide credentials, such as a user name and/or password. The virtual computing environment may consume an entire display and prevent access to software and/or hardware not related to the operation of the virtual computing environment. For example, access to a hard disk drive, or software other than that allowed by the instructions on the external storage device may be limited or denied.

The virtual computing environment may provide security for the transfer of data from to the network. In some embodiments, access to the network may be limited or denied until certain information is verified. In some embodiments, a check may verify that the external storage device is coupled to the first computing device and that the hardware and/or software of the first device is consistent with predefined company policies.

In some embodiments, the external storage device may pair with a single computing device and may not function with another computing device. Moreover, in some embodiments, the content stored on the external storage device may not be manipulable. If the content is changed, the secure operating environment may not be instantiated. In some embodiments, content added to the external storage device may be deleted.

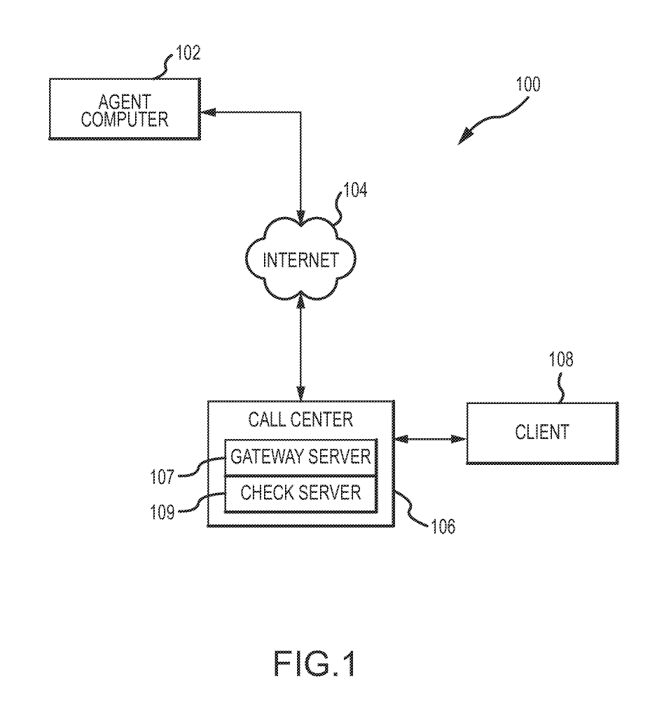

Turning to the drawings and referring initially to FIG. 1, a computing network 100 is illustrated having an agent computer 102, a call center 106 and a client 108. Generally, the agent computer 102 may communicate with the call center 106 via a network, such as the Internet 104. It should be appreciated, that the network may include any suitable network configuration and a number of network devices. For example, the network may include a local area network, a wide area network, a WiFi network, an Ethernet network, and/or the like. Additionally, the network may include routers, servers and/or other devices configured to facilitate electronic communication.

The call center 106 may generally include one or more computing systems configured to receive, store and/or communicate information to the agent computer 102 and the client 108. Terms such as the “agent,” the “agent computer,” the “agent computing device,” the “computing device,” and the like may be used herein to refer to the agent computer 102. The call center 106 may include a gateway device 107 and a check server 109 configured to limit access to the call center. The check server 109 may be a file server and may be referred to herein as a “file server”. As such, the gateway device 107 and check server 109 may be implemented for security purposes. Communications from the agent 102 may be routed to the gateway device 107 for verification of the user (e.g., via a username) and once verified, additional information may be checked or verified by the check server 109. In particular, the check server 109 may verify the contents of the agent computer 102, including the installed hardware and/or software and/or whether it has been manipulated. In particular, The call center 106 is also configured to communicate with a client computing system 108. In some embodiments, the call center 106 may communicate with the client computing system 108 via the Internet 104, although the communications may be via any suitable network.

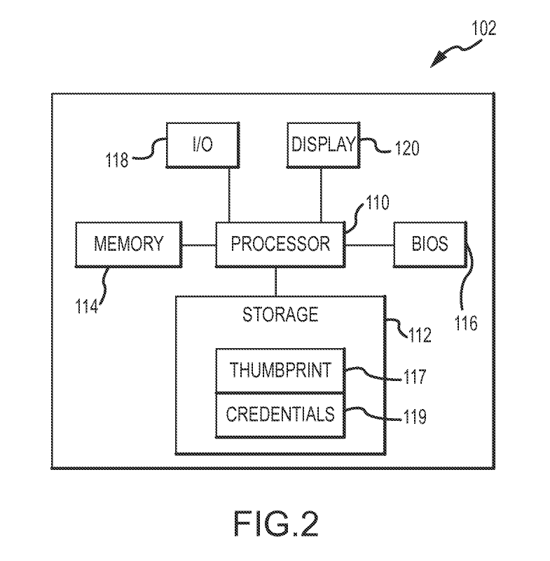

FIG. 2 is a block diagram of an example agent computing device 102. The agent computing device 102 includes a processor 110, a storage medium 112, memory 114, BIOS 116, I/O 118, and a display 120. It should be appreciated that the agent computing device 102 illustrated in FIG. 2 is provided as an example and an actual implementation may include more, fewer and/or different component parts. The storage media 112 may be a computer readable medium configured to store data and instructions executable by the processor 110. The storage medium 112 may take any suitable form including, optical drives, magnetic drives, semiconductor drives, and so forth. The memory 114 is also a computer readable medium and may take any suitable form including one or more types of random-access memory (RAM), for example.

The BIOS 116 may store information that enables the booting of the agent computing device 102. Upon start up of the device 102, the BIOS 116 may determine a configuration of the agent 102 including determining what hardware is present and operational within the device. Additionally, the BIOS 116 finds software, such as an operating system, located in the storage 112 and initiates its execution. The configuration information determined by the BIOS 116 may be used in security checks when the agent 102 attempts to connect with the call center 106.

In some embodiments, the storage 112 may store information for the security checks. For example, in some embodiments, a thumbprint file 117 may be stored in a particular location and/or user credentials 119. The thumbprint file 117 may include information that identifies the particular agent computing device 102. For example, the thumbprint file may include information such as serial numbers for the processor, storage, and storage devices, among other things. The credentials 119 may include a username and password against which user-provided login information may be compared.

The agent computing device 102 may have intentionally limited functionality. For example, in some embodiments, the I/O 118 may be limited to keyboard and mouse ports. That is, the motherboard may not provide support for connecting with other I/O devices. Additionally, in some embodiments, the software booted by the BIOS 116 may be tailored to limit access to certain resources. For example, the software may restrict access to data stored in the storage 112. Moreover, the BIOS 116 may be configured to disable or not recognize hardware that may be installed into the agent computing device 102 by a user. As such, the device 102 may be limited to the hardware originally installed.

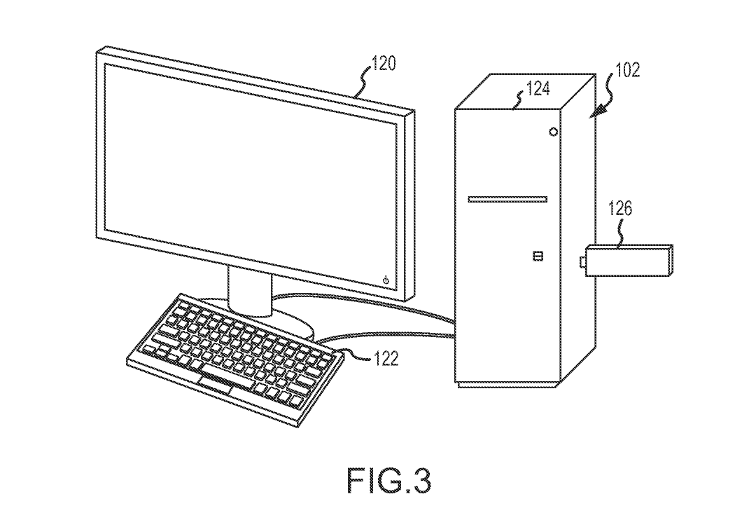

FIG. 3 illustrates the agent computing device 102 and an external storage device 126. As illustrated, the agent computing device 102 is a desktop system having the display 120, a keyboard 122, and a housing 124. In other embodiments, the agent computing device 102 may take other forms, such as a notebook computer or tablet computing device, for example. The external storage device 126 may take any suitable form, such as a jump drive, a MultiMediaCard, a Secure Digital card, or the like, utilizing flash memory or other type of memory. The external storage device 126 may couple to the agent computing device via a suitable I/O port, such as a universal serial bus (USB) port, for example.

The external storage device 126 may store instructions executable by the agent computing device 102 to help secure the computing environment for communication with the call center 106. For example in some embodiments, the external storage device 126 may contain instructions that when executed provide a virtual desktop environment that requires a user to login. The virtual desktop may be implemented as a VM Ware Ace virtual machine or other suitable virtual machine software. Additionally, the virtual desktop may limit or deny access to resources of the agent computing device 102. In some embodiments, files may be down loaded or otherwise saved in storage 112 so that when the external storage device 126 is communicatively coupled to the agent 102, the virtual desktop is booted and a “kiosk” mode is initiated that takes up the entire display 120, thus preventing access to other resources. In some embodiments, the device 102 cannot exit the kiosk mode without shutting down the device and access to hardware, such as the storage 112 may be limited.

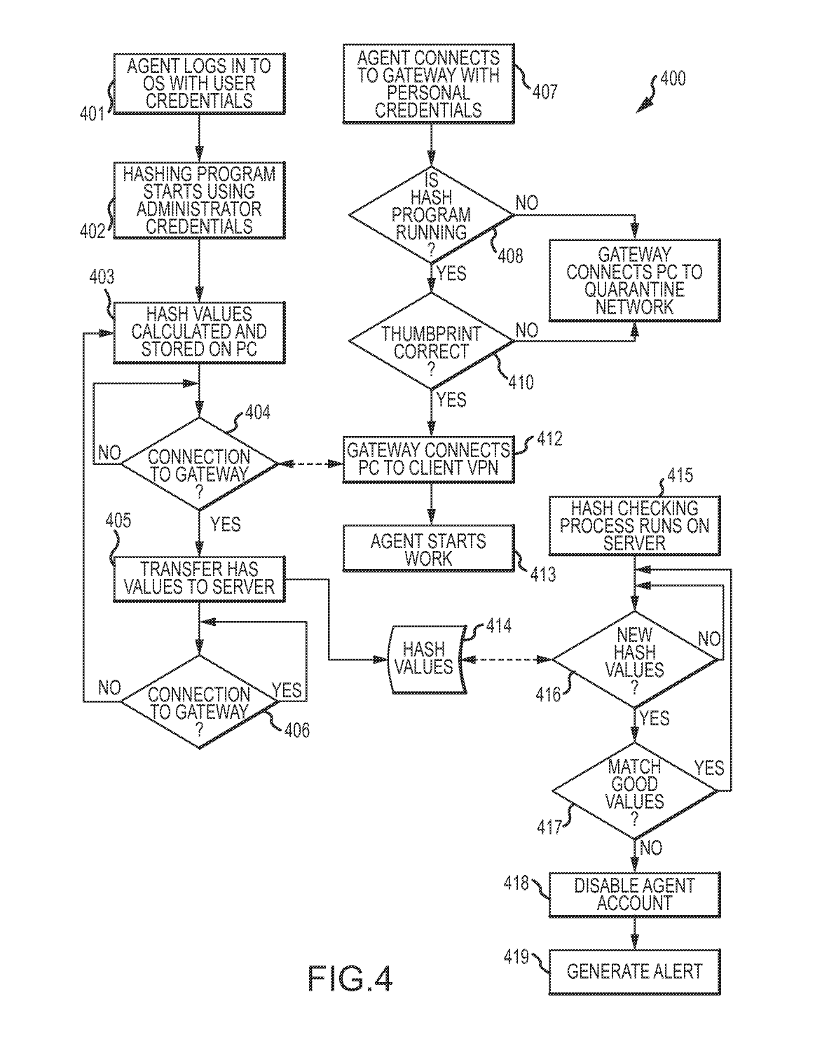

FIG. 4 is a flow chart illustrating a method 130 for providing security for communications between the agent 102 and the call center 106. Initially, the agent logs in to the workstation using supplied credentials (Block 401). A hashing program is automatically started using stored administrator credentials. If any changes have been made to the administrator account, the job will fail. The hashing program calculates hash values for several critical areas that would reveal any tampering on the workstation. The hash values are stored in files on the workstation (Block 403). Generally, the hashing program may convert computer identifying information (such as meta data and/or contents of files) into a value, such as an integer. The value may be used to identify the computer and its contents. That is, the calculated hash value may be compared with stored hash value(s) to determine the identity of a computer and/or recognize if any changes have been made to the content of the computer.

The hashing program begins looping while watching or polling active services for a connection to the gateway device (Block 404). In some embodiments, the processing done by the hashing program is done without a user interface so the agent is unable to interrupt or modify any of the process.

After the agent has logged in to the workstation (and while the hashing program is performing its functions) the agent initiates a connection to the gateway device using their personal credentials (Block 407). The gateway device interrogates the workstation for the status of the hashing program (Block 408). If the hashing program is not running, the workstation is connected to a quarantine network (Block 409) where diagnostics can be performed but there is no access to the call center 102. The gateway device examines the contents of the thumbprint file (Block 410). If the value in the file does not match the expected value, the workstation is connected to a quarantine network (Block 409) where diagnostics can be performed but there is no access to the call center (Block 102). If the workstation passes the two checks and the agent credentials are accepted, the workstation is connected to the call center (Block 412) and the agent can begin work (Block 413).

The hashing program detects whether a connection to the gateway has been made (Block 404) and initiates a transfer of the stored hash files to a centrally located file server (Block 405). The hashing program begins looping while watching active services for a disconnection from the gateway device (Block 406). If the agent disconnects from the gateway device, the hashing process is restarted (Block 403).

A process running on the file server monitors the location where hash files are transferred (Block 415). When new hash values are detected (Block 416) they are imported to a data base and compared to known good values (Block 417). Any values that are unknown would indicate tampering on the machine. This triggers a process that disables the agent's account (Block 418) and generates an alert on the monitoring system (Block 419).

The foregoing techniques may be utilized to help provide a secure environment for an agent computing device to connect and communication with a call center, its network, and/or a client. Other security measures may be implemented in lieu of or in combination with those already discussed. Moreover, in some embodiments, one or more security measures may be implemented independently from the others and/or security measures may be implemented without using all of the features.

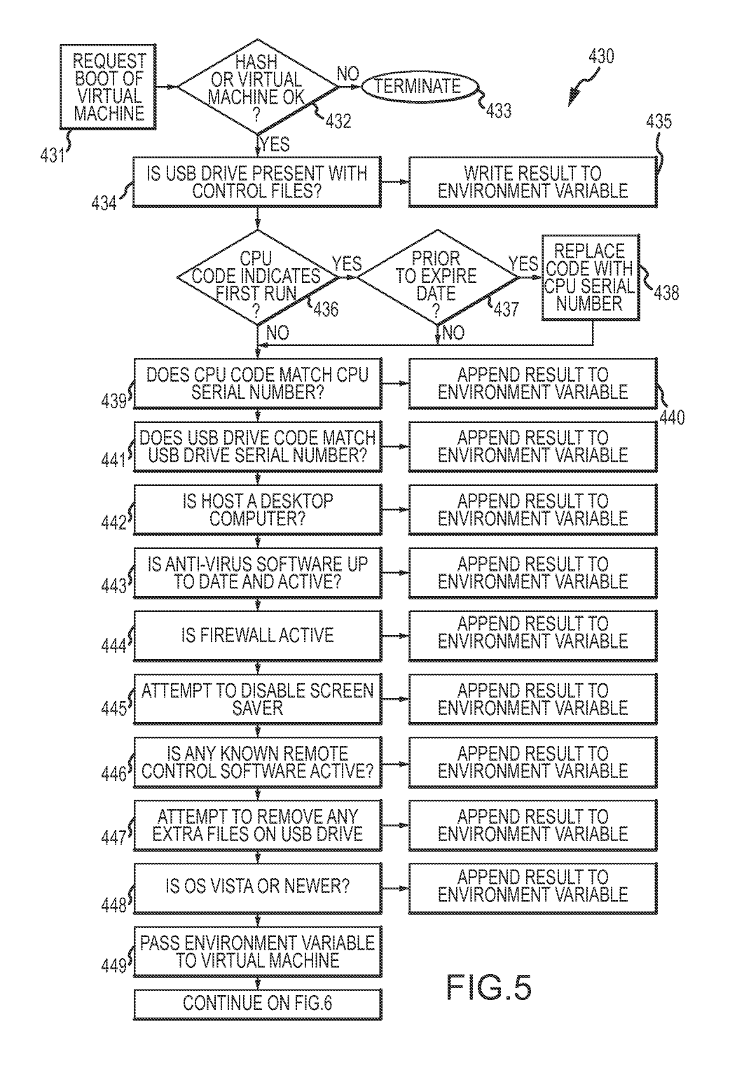

FIG. 5 is a flowchart illustrating a method 430 implementing security measures in conjunction with receiving an external storage device, such as a jump drive. Initially, a drive having security software is received by the agent computing device. That is, the jump drive may be communicatively coupled to the agent computer. The agent computing device may then boot a virtual machine or virtual desktop environment from the drive (Block 431). A hash of the virtual machine may be verified (Block 432) by the virtualization software, such as software distributed by VMWare, Inc., installed on the agent computing device. If the hash value shows evidence of tampering or corruption, the process is terminated (Block 433). That is, a hash of the virtualization software is compared with a stored hash and if the two do not coincide (i.e., are not identical), then the process may be terminated.

A number of tests may be performed to determine if the external storage device and the agent computing device have been paired together as well as to determine if the files on the external storage device have been moved to a different device. Tests of the suitability of the agent computing device may be performed as well. The results of these tests are passed through to the virtual machine where action is taken if needed.

The first test may be a check if there is a universal serial bus (USB) storage device present and/or if the necessary control files are present (Block 434). The data in control files, which may be stored locally on the agent computing device or remotely on the network, may include the serial number of the agent's computing device, the serial number of the storage device and/or a list of files that are included on the storage device when it was shipped to the agent. All control files are encrypted to prevent tampering. A code indicating the success or failure of this test may be written to an environment variable that will be passed to the virtual machine (Block 435).

Pairing of the storage device and the agent computing device may be managed through one of the control files. The central processing unit (CPU) serial number and activation expiration date are read from the file and decrypted. If the CPU serial number is a pre-defined activation code (Block 436) and the activation expiration date has not passed (Block 437), a query is executed that returns the serial number of the CPU in the agent's computing device. The pre-defined activation code may be a known code that is loaded onto the storage device at a location for storage of a CPU serial number to indicate that it has not yet been paired with a computing device. The serial number is encrypted and replaces the pre-defined activation code (Block 438). Hence, once a storage device has been paired with a computing device, the pre-defined activation code is no longer present on the storage device.

If the CPU serial number is not the pre-defined activation code, it is compared to the serial number of the CPU in the agent's computing device (Block 439). The results of the comparison (Y or N, or other suitable variables) may be appended to the environment variable (Block 440). Yes may indicate that the agent computing device and the storage device are paired together. No may indicate that the storage device and the agent computing device are not paired together and the test has failed. Failure of this test indicates that the storage device is being used in a computing device other that the one in which it was originally activated.

A variety of other tests may also be performed to evaluate the condition of the agent's computing device. These test may be run by the host device and passed to the virtual machine, and/or the file server. For example, each test may evaluate to a Yes or No and the results are appended as a Y or N, or some other suitable variable, to the environment variable. The tests are as follows:

Does the serial number of the USB storage device match the encrypted value stored in the control file on the USB storage device (Block 441)? This may indicate the files have been copied to a different storage device. That is, if the value stored in the control file does not match that of the serial number of the USB storage device, the encrypted value has been taken from another storage device.

Is the agent's computing device a desktop computer (Block 442)? This allows the ability to restrict access to notebook and tablet computers. For example, a call center may distribute a particular type of computing device (e.g., a notebook) to agents. Therefore, access to the call center by another type of device (e.g., desktop) would likely be from an unauthorized devices.
Is anti-virus software active and up to date (Block 443)? This helps insure that the computing device is relatively clean and malware is not running on the host which could compromise communications and/or be passed into the call center network.
Is the firewall active (Block 444)? Checks for either the Microsoft firewall or third party product to achieve a level of security with respect to access to communications with the call center.
Attempt to disable screen saver (Block 445). When the host screen saver is activated it may allow the user access to the host system. Hence, the screen saver may be disabled to help prevent access to the host system while the virtual operating environment is active. Reports “Y” if screen save is disabled.
Is any known remote control software active (Block 446)? Look for some software packages that will allow the host computer to be operated from a remote location. In some embodiments, upon discovery of active remote control software, an attempt may be made to limit or eliminate remote access.
Attempt to remove any extra files on USB drive (Block 447). List of files currently on the storage device is compared to an encrypted list made when the drive was created. If additional files are found, an attempt may be made to remove them from the USB drive.
An “N” would be reported if files were found and the attempt to remove them failed.
Is host operating system an acceptable operating system (Block 448)? This allows the ability to restrict the host machine to newer environments. For example, if the host operating system is Microsoft Vista® or a newer Microsoft operating system, then it may be determined to be an acceptable operating system.
The results of each test may be appended to the environment variable (Block 440) that is subsequently made available to the virtual machine. Additional tests of the agent's computing device can be added easily as the results may be appended to the existing environment variable. In some embodiments, the test may be run locally and results reported to the file server at the call center.

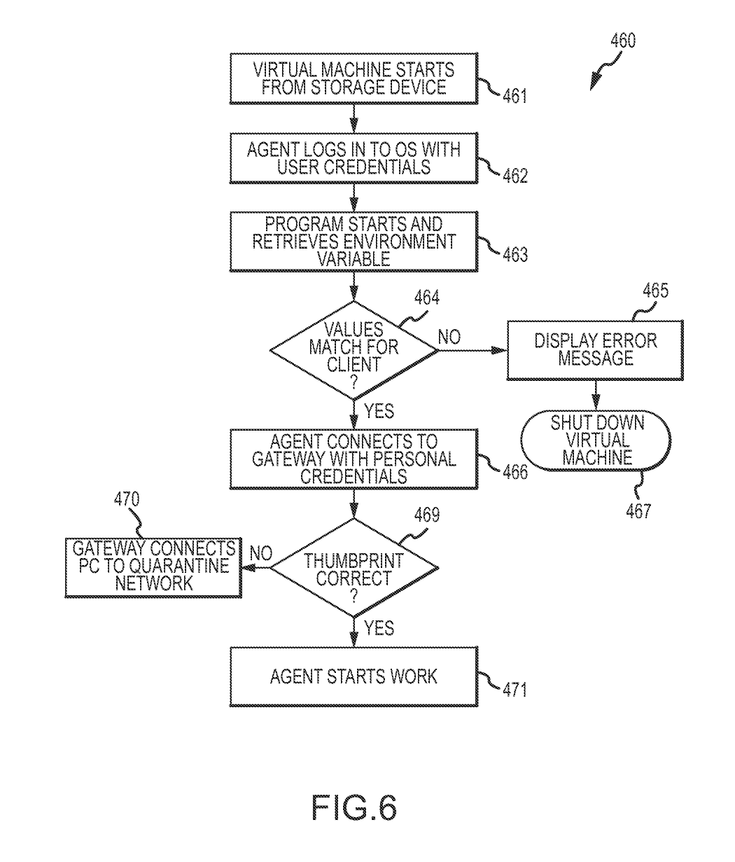

FIG. 6 is a flowchart illustrating a method 460 for implementing a secure computing environment using the results of the tests performed in method 430. At the completion of the steps in method 430, the virtual computer boots from the storage device (Block 461). The agent may log in to the virtual machine using supplied credentials (Block 462). A check program is automatically started using stored administrator credentials and retrieves the environment variable (Block 463) including those that were appended in the method of FIG. 5.

A file accessible only to administrators is stored on the virtual machine that contains a “mask” of which test results are relevant to a particular client. For example, the mask may contain a “Y” in the position related to anti-virus. This would mean that the environment variable must match the “Y” to pass the check. Alternately, the mask may contain a “D” in the position related to the desktop computer test. This indicates that the client doesn't care and the environment variable would pass the check with a “Y” or “N”. The mask allows the security to be fine tuned to the needs of each client. That is, some clients may require that the firewall be installed and operating and other clients may not. The environment variable is compared to the mask (Block 464). If any checks fail an error message is displayed (Block 465) and the virtual machine is shut down (Block 467). If all checks pass, the virtual machine continues to run and the agent will initiate a connection to the gateway device using their personal credentials (Block 466). The gateway device may examine the contents of the thumbprint file (Block 469). If the value in the file does not match the expected value the virtual workstation is connected to a quarantine network (Block 470). If the thumbprint file is correct and the agent credentials are accepted, the virtual workstation is connected to the call center and the agent can begin work (Block 471).

The foregoing discussion describes some example embodiments to achieve a secure computing environment. Although the foregoing discussion has presented specific embodiments, persons skilled in the art will recognize that changes may be made in form and detail without departing from the spirit and scope of the embodiments to achieve the similar security provided by the embodiments disclosed herein. Moreover, one or more steps of a particular method described herein may be interchangeable with and/or utilized within one or more other methods described herein. Accordingly, the specific embodiments described herein should be understood as examples and not limiting the scope of the disclosure.

1. A secure computing environment for accessing a network comprising:
an agent computing device comprising:
a processor; and
a memory coupled to the processor storing instructions executable by the processor to provide secure call center functionality;
wherein the agent computing device is configured to generate a first hash value; and
a gateway device comprising:
a second processor; and
a memory coupled to the second processor storing a second hash value, wherein the gateway device is configured to verify the first hash value prior to allowing the agent computing device access to a network.

2. The secure computing environment of claim 1 further comprising an external storage device selectively coupleable to the agent computing device, the external storage device storing instruction executable by the agent computing device.

3. The secure computing environment of claim 2 wherein instructions stored on the external storage device are executable to instantiate a virtual desktop.

4. The secure computing environment of claim 1, wherein the first hash value comprises a value representative of the hardware installed on the agent computing device.

5. The secure computing environment of claim 1, wherein the first hash value comprises a value representing at least the software installed on the agent computing device.

6. The secure computing environment of claim 1, wherein the gateway device is configured to verify that a hash program is operating on the agent computing device's operating system.

7. A method of pairing an external storage device with a computing device comprising:
reading a first code from the external storage device;
if the first code indicates a default value:
reading an expiration date from the external storage device; and
determining if the expiration date has passed;
if the expiration date has not passed, replacing the first code with a second code to pair the external storage device with the computing device; and
if the first code does not indicate the default value, comparing the first code matches with third code stored on the computing device to determine if the external storage device has been paired with the computing device.

8. The method of claim 7, wherein the second code comprises a serial number of a hardware device of the computing device.

9. The method of claim 8, wherein the second code comprises a serial number of a processor.

10. The method of claim 7 further comprising comparing a fifth code with a sixth code to determine if the computing device has been paired with the external storage device.

11. The method of claim 10, wherein the fifth code comprises a serial number for the external storage device.

12. The method of claim 7 further comprising determining if the external storage device is presently coupled to the computing device.

13. The method of claim 7 further comprising:
computing a hash value of a virtual machine executable from the external storage device;
comparing the hash value to a second hash value stored at the computing device; and
terminating instantiation of the virtual machine if the hash value does not coincide with the second hash value.

14. The method of claim 7 further comprising appending a result of the comparison between the first and third codes to an environment value and passing the environment value to a virtual machine operating on the computing device.

15. The method of claim 10 further comprising appending a result of the comparison between the fifth and sixth codes to an environment value and passing the environment value to a virtual machine operating on the computing device.

16. A method of providing a secure computing environment comprising:
requesting, by a processor, booting of a virtual machine on a first computing device;
verifying a hash value of the virtual machine;
determining if an external storage device is present in the first computing device and writing the result of the determination to an environment variable;
confirming that the external storage device is paired with the first computing device and writing the result of the confirmation to an environment variable; and
booting the virtual machine on the first computing device.

17. The method of claim 16 further comprising writing the results of at least one of the following queries to the environment variable:
is the host a desktop computer;
is an antivirus software package current;
is a firewall active;
is a remote control software package; and
is an operating system current.

18. The method of claim 16 further comprising writing the results of at least on of the following attempts to the environment variable:
attempt to disable a screen saver; and
attempt to remove extra files from the external storage device.

19. The method of claim 16 further comprising:
passing the environment variable to the virtual machine;
verifying the environment variable for a client;
displaying an error message if the environment variable is not verified for the client; and
connect the first computing device to gateway computing device.

20. The method of claim 19 further comprising:
verifying a thumbprint file with a file stored at the gateway computing device; and
allowing access to network if the thumbprint is verified.
